(19) United States
(12) Patent Application Publication
(10) Pub. No.: US 2014/0255733 A1
(43) Pub. Date: Sep. 11, 2014

(54) AIRCRAFT FUEL CELL SYSTEM WITH CATALYTIC BURNER SYSTEM

(71) Applicant: Zodiac Aerotechnics, Plaisir Cedex (FR)

(72) Inventors: Franck Masset, Saint Georges Motel (FR); Yannick Brunaux, Croix (FR)

(73) Assignee: Zodiac Aerotechnics, Plaisir Cedex (FR)

(21) Appl. No.: 14/200,964

(22) Filed: Mar. 7, 2014

Related U.S. Application Data
(60) Provisional application No. 61/774,955, filed on Mar. 8, 2013.

(51) Int. Cl. B64D 41/00; H01M 8/04; H01M 8/06

(52) U.S. Cl. CPC B64D 41/00; H01M 8/0662; H01M 8/04022
USPC 429/8; 429/436; 429/408

(57) ABSTRACT

Disclosed are fuel cell systems used as power sources aboard aircraft and utilizing catalytic systems. Fuel cell systems can include a fuel cell assembly and a catalyst system. The fuel cell assembly can receive a hydrogen input, receive an oxygen input comprising a fluid having an initial oxygen content, and convert the hydrogen input and the oxygen input so as to yield products, such as water, thermal energy, an oxygen-depleted product comprising the fluid having a second oxygen content lower than the initial oxygen content, and electrical power. The fuel cell assembly can supply any combination of such products to aircraft operational systems. The catalyst system can receive and combust hydrogen from the fuel cell assembly and/or a hydrogen storage vessel, such as to treat exhaust from the fuel cell assembly and/or provide heat for warming water and/or for regulating operating temperatures of fuel cell system components.

### CROSS-REFERENCES TO RELATED APPLICATIONS

This application claims the benefit of U.S. Provisional Application No. 61/774,955, entitled “FUEL CELL SYSTEM WITH INTEGRATED CATALYTIC BURNER,” Mar. 8, 2013 (Attorney Docket No. 41052/869352 or 93358-869352), the entire disclosure of which is hereby incorporated herein by reference.

### BACKGROUND OF THE INVENTION

Vast numbers of people travel every day via aircraft, trains, buses, and other commercial vehicles. Such commercial vehicles are often outfitted with components that are important for passenger comfort and satisfaction. For example, commercial passenger aircraft can have catering equipment, heating/cooling systems, lavatories, water heaters, power seats, passenger entertainment units, lighting systems, and other components. A number of these components on-board an aircraft require electrical power for their activation. Although many of these components are separate from the electrical components that are actually required to run the aircraft (i.e., the navigation system, fuel gauges, flight controls, and hydraulic systems), an ongoing concern with these components is their energy consumption. Frequently, such systems require more power than can be drawn from the aircraft engines' drive generators, necessitating additional power sources, such as a kerosene-burning auxiliary power unit (APU) (or by a ground power unit if the aircraft is not yet in flight). Energy from these power sources may have to travel a significant distance to reach the power-consuming components, resulting in loss of power during transmission and a reduction in overall efficiency of power systems. The total energy consumption can also be rather large, particularly for long flights with hundreds of passengers, and may require significant amounts of fossil fuels for operation. Additionally, use of aircraft power typically produces noise and CO₂ emissions, both of which are desirably reduced.

The relatively new technology of fuel cell systems provides a promising cleaner and quieter means to supplement energy sources already aboard commercial crafts. A fuel cell system produces electrical energy as a main product by combining a fuel source of liquid, gaseous, or solid hydrogen with a source of oxygen, such as oxygen in the air, compressed oxygen, or chemical oxygen generation. A fuel cell system has several outputs in addition to electrical power, and these other outputs often are not utilized and therefore become waste. For example, thermal power (heat), water, and oxygen-depleted air (ODA) are produced as by-products. These by-products are far less harmful than CO2 emissions from current aircraft power generation processes.

Furthermore, significant variations in operating conditions for fuel cell systems may occur. Such variations may lead to unpredictability regarding the amount of resources needed for a particular flight, reduce efficiency of the fuel cell systems, and/or otherwise negatively affect operation of components aboard the craft. As such, systems that may be implemented to further enhance the functionality of fuel cell systems aboard aircraft are desirable for improving efficiency and operational life of components aboard the craft.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

As an example embodiment, disclosed is a fuel cell system for an aircraft. The fuel cell system can include a hydrogen storage vessel, a fuel cell assembly, and a catalyst system. The fuel cell assembly can be configured to receive a hydrogen input comprising hydrogen from the hydrogen storage vessel, receive an oxygen input comprising a fluid having an initial oxygen content, and convert the hydrogen input and the oxygen input so as to yield a number of products. The products can include a water product comprising water, a heat product comprising heat, an oxygen-depleted product comprising the fluid having a second oxygen content lower than the initial oxygen content, and an electric product comprising electrical power. The fuel cell assembly can supply any combination of these products to one or more operational systems of the aircraft. The catalyst system can receive and combust hydrogen from the fuel cell assembly and/or the hydrogen storage vessel. The hydrogen combustion can treat exhaust from the fuel cell system and/or provide heat for warming water (such as for operational systems of the aircraft) and/or for warming fuel cell system components (such as during a start-up phase).

In a further example embodiment, a method is provided for distributing heat from a catalyst system associated with a fuel cell system for an aircraft. The method can include providing a fuel cell system and a catalyst system aboard an aircraft, generating heat via the catalyst system, and routing the generated heat to the fuel cell system, a hydrogen storage vessel, and/or a water source for an operational system of the aircraft.

For a fuller understanding of the nature and advantages of the present invention, reference should be made to the ensuing detailed description and accompanying drawings.

### BRIEF DESCRIPTION OF THE DRAWINGS

The specification makes reference to the following appended figures, in which use of like reference numerals in different figures is intended to illustrate like or analogous components.

FIG. 1 is a diagram illustrating the inputs and outputs of a fuel cell system and non-limiting examples of how the outputs can be used according to certain embodiments.

FIG. 2 is a diagram illustrating operation of an example of an aircraft-based fuel cell system according to certain embodiments.

FIG. 3 is a diagram illustrating an example of a catalytic burner system according to certain embodiments.

FIG. 4 is a diagram illustrating an example of an aircraft-based fuel cell system including a catalyst system configured for treating exhaust according to certain embodiments.

FIG. 5 is a diagram illustrating an example of an aircraft-based fuel cell system including a catalyst system configured for heating water according to certain embodiments.

FIG. 6 is a diagram illustrating an example of an aircraft-based fuel cell system including a catalyst system configured for heating components of the fuel cell system according to certain embodiments.

FIG. 7 is a diagram of a computer apparatus, according to certain embodiments.

FIG. 8 is a simplified flow diagram illustrating a method for distributing heat from a catalyst system associated with a fuel cell system aboard an aircraft, according to certain embodiments.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Disclosed herein are fuel cell systems used as a power source aboard aircraft and utilizing catalytic burner systems. For example, catalytic burner systems integrated with fuel cell systems may be configured to reduce unconsumed fuel in exhaust, to heat water for use aboard the aircraft, and/or to regulate operating temperatures of components associated with the fuel cell systems. While such fuel cell technology is discussed herein in relation to use in aircrafts, it is by no means so limited and may be used in buses, trains, spacecraft, or other forms of transportation equipped with fuel cell systems.

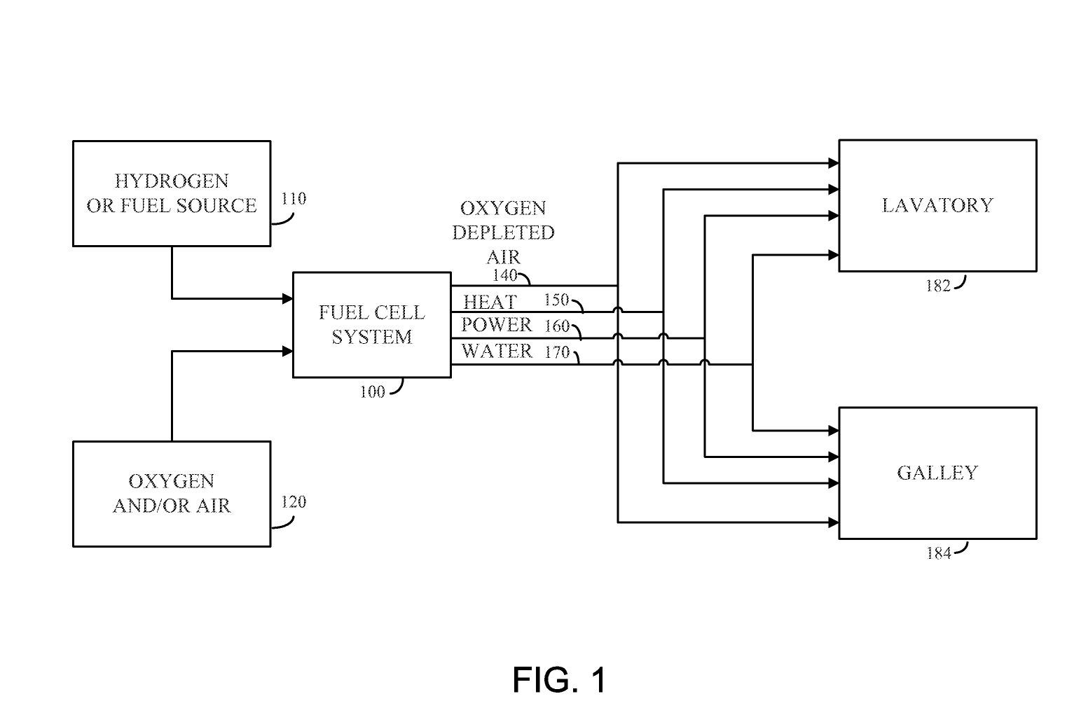

A fuel cell system is a device that converts chemical energy from a chemical reaction involving hydrogen or other fuel source and oxygen-rich gas (e.g., air) into electrical energy. As illustrated in FIG. 1, a fuel cell system 100 combines an input of hydrogen or another fuel source 110 with an input of oxygen 120 to generate electrical energy (power) 160. In certain embodiments, one or more inverters may be included to provide alternating current (“AC”) power to those applicable loads that utilize AC power. Along with the generated electrical energy 160, the fuel cell system 100 produces water 170, thermal power (heat) 150, and oxygen-depleted air (ODA) 140 as by-products. As further illustrated in FIG. 1, some or all of the fuel cell output products of electrical energy 160, heat 150, water 170, and ODA 140 may be used to operate systems aboard the aircraft. For example, the fuel cell output products can be supplied to operational systems of the aircraft, such as, but not limited to, systems of a lavatory 182 or a galley 184 aboard the aircraft. Output products can additionally and/or alternatively be routed to other operational systems or areas for use where such output products are useful, including, but not limited to, routing to aircraft wings for ice protection, to showers, to passenger cabins, to passenger seats, and/or to fuel tanks. One or more than one output product can be utilized in any given location, and any given output product may be utilized in one or more locations. Exemplary, but non-limiting, examples of aircraft systems utilizing fuel cell output products are disclosed in International Patent Application No. PCT/US13/030,638, entitled “FUEL CELL SYSTEM POWERED LAVATORY,” filed Mar. 13, 2013 (Applicant's File Reference No. 862890); International Patent Application No. PCT/IB2013/052004, entitled “POWER MANAGEMENT FOR GALLEY WITH FUEL CELL,” filed Mar. 13, 2013 (Applicant's File Reference No. 862904); International Patent Application No. PCT/IB2013/051981, entitled “WING ICE PROTECTION SYSTEM BASED ON A FUEL CELL,” filed Mar. 13, 2013 (Applicant's File Reference No. 867034); and International Patent Application No. PCT/IB2013/051979, entitled “VEHICLE SEAT POWERED BY FUEL CELL,” filed Mar. 13, 2013 (Applicant's File Reference No. 867034), the entire disclosures of which are hereby incorporated herein by reference.

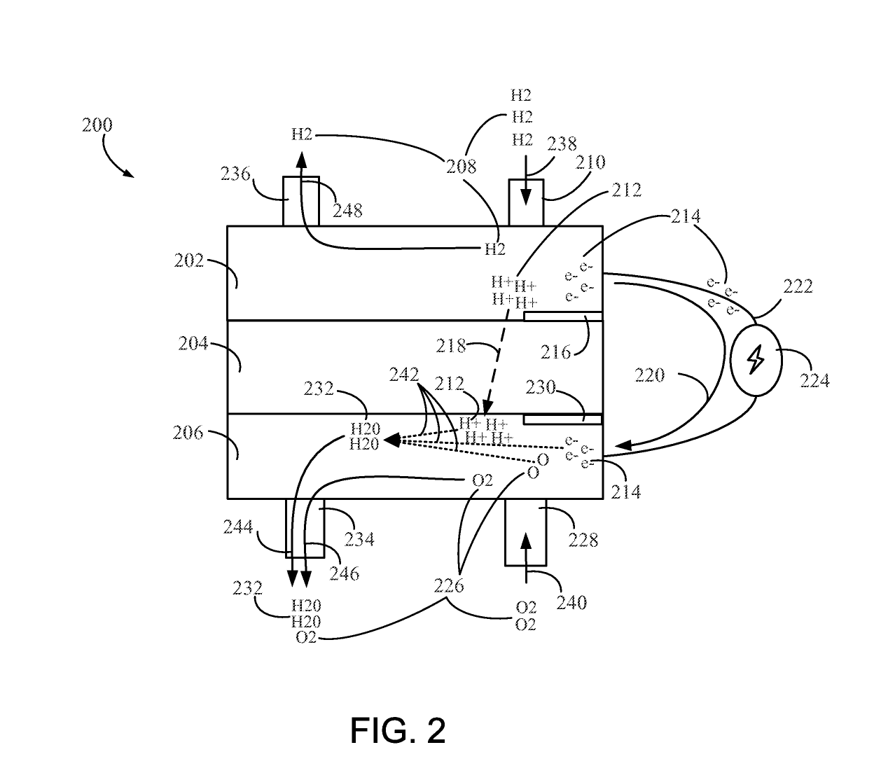

Any appropriate fuel cell system 100 may be used, including, but not limited to, a Proton Exchange Membrane Fuel Cell (PEMFC), a Solid Oxide Fuel Cell (SOFC), a Molten Carbonate Fuel Cell (MCFC), a Direct Methanol Fuel Cell (DMFC), an Alkaline Fuel Cell (AFC), or a Phosphoric Acid Fuel Cell (PAFC). Any other existing or future fuel cell system technology, including, but not limited to, a hybrid solution, may also be used. Although any appropriate fuel cell system 100 may be used, several features and functions shared by many of the aforementioned fuel cell systems may be appreciated with reference to FIG. 2.

FIG. 2 is a diagram depicting operation of an example of an aircraft-based fuel cell system 200 according to certain embodiments. However, as may be understood, FIG. 2 merely depicts an illustrative example of a fuel cell system 200, and other fuel cell systems may be utilized alternatively and/or additionally.

The fuel cell system 200 depicted in FIG. 2 includes an anode 202, an electrolyte 204, and a cathode 206. Fuel containing hydrogen 208 is introduced to the anode 202 via an anode intake 210 (shown by arrow 238). The presence of a first catalyst (such as platinum) 216 may be utilized to facilitate and/or increase a rate of a first chemical reaction in which the hydrogen 208 separates into constituents including hydrogen ions 212 and electrons 214. The electrolyte 204 permits passage therethrough of the hydrogen ions 212 (shown by dashed arrow 218) and prevents passage of the electrons 214, such that the electrons 214 are routed through a conductive path 222 external to the electrolyte 204 (shown by arrow 220). Passage of the electrons 214 through the conductive path 222 can provide electrical power to an electrical load 224 connected with the conductive path 222.

At the cathode 206, oxygen 226 is provided via a cathode intake 228 (shown by arrow 240), electrons 214 are communicated via the conductive path 222 (shown by arrow 220), and hydrogen ions 208 are introduced via the electrolyte 204 (shown by dashed arrow 218). Water 232 is formed in a second chemical reaction by the combination of said oxygen 226, hydrogen ions 212, and electrons 214 (reaction shown by dotted arrows 242). The presence of a second catalyst 230 may be utilized to facilitate and/or increase a rate of this second chemical reaction. The water 232 and any excess oxygen 226 are transferred out of the cathode 206 via a cathode exhaust outlet 234 (shown by arrows 244 and 246). Excess hydrogen 208 is transferred out of the anode 202 via an anode exhaust outlet 236 (shown by arrow 248). Heat may also be produced in the fuel cell system 200 (such as via the first chemical reaction and/or the second chemical reaction) and utilized in various applications aboard the aircraft, along with the water, the electrical power, and the oxygen depleted gas produced by the fuel cell system 200.

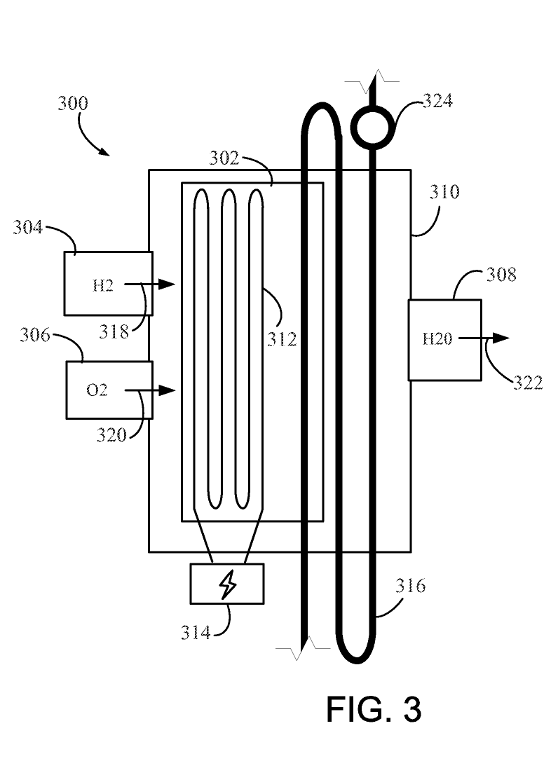

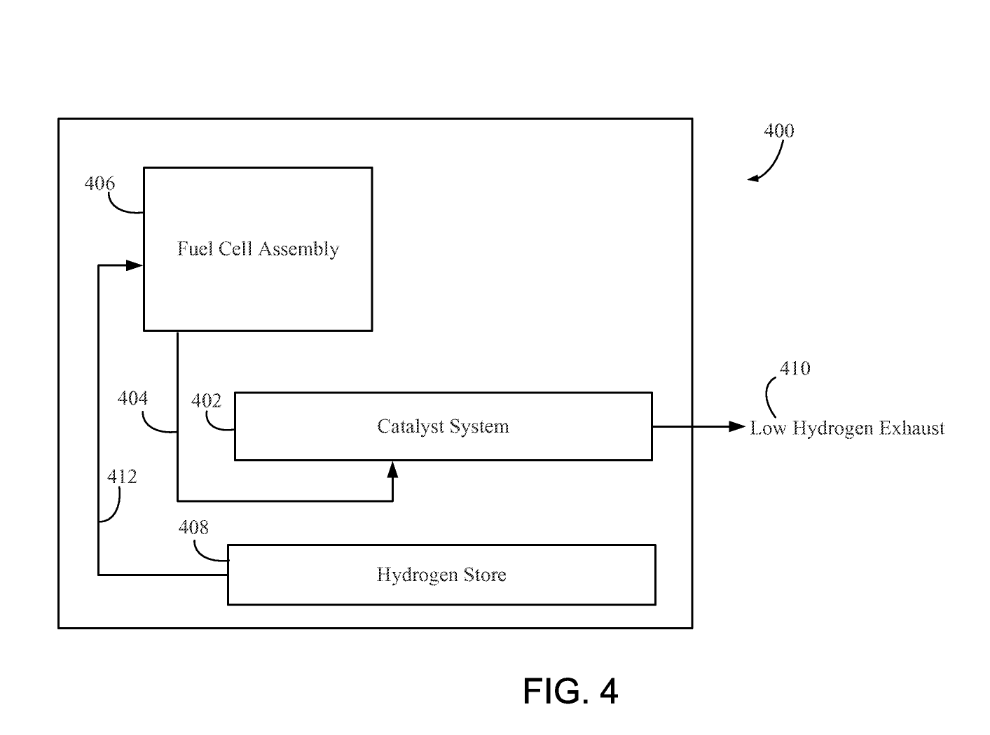

Aircraft-based fuel cell systems (such as fuel cell systems 100 and/or 200) can be configured to operate with catalytic burner systems to provide various functions, which may include those functions discussed in more detail with respect to FIGS. 4-8 below. FIG. 3 is a diagram depicting an example of such a catalytic burner system 300 according to certain embodiments. However, as may be understood, FIG. 3 merely depicts an illustrative example of a catalytic burner system 300, and other catalytic burner systems may be utilized alternatively and/or additionally.

The catalytic burner system 300 can include a catalyst layer 302, a hydrogen inlet 304, an oxygen inlet 306, and a system exhaust 308. The catalyst layer 302 can include a catalyst that can induce oxygen and hydrogen to undergo a combustion reaction at a lower temperature and/or in less time than in the absence of the catalyst. The presence of the catalyst may allow hydrogen and oxygen to combust without a spark or other ignition source. In some aspects, a catalytic burner system 300 can produce a greater amount of heat than is produced by consuming an equivalent amount of hydrogen in a fuel cell system (such as fuel cell system 100 or 200, described above with respect to FIGS. 1 and 2). A non-limiting example of the catalyst is platinum. In some aspects, the rate and/or ignition temperature of a combustion reaction of hydrogen and oxygen is related to the temperature of the catalyst. For example, hydrogen and oxygen may not combust in the presence of a particular catalyst until the temperature of the catalyst has been raised to above a certain threshold.

The catalyst layer 302 can be coupled with a heating element 312. Non-limiting examples of the heating element 312 include an electric wire grid and/or coil. The heating element 312 can be coupled with a power source 314. Non-limiting examples of the power source include an electrical energy storage device (such as a battery or a capacitor), a generator (including, but not limited to, an aircraft-based fuel cell system), a power grid (such as a power network of an aircraft), and combinations thereof. Energy communicated from the power source 314 can increase the temperature of the heating element 312, which can in turn raise the temperature of the catalyst in the catalyst layer 302.

The catalyst layer 302 can be positioned in a chamber 310. The hydrogen inlet 304 can introduce hydrogen toward the catalyst layer 302 (shown by arrow 318), such as into the chamber 310. In some aspects, the hydrogen may be provided in the form of a fuel containing hydrogen, such as the fuel used for the fuel cell system 200. Additionally or alternatively, the hydrogen may be provided via the anode exhaust outlet 236 described above with respect to FIG. 2. The oxygen inlet 306 can introduce oxygen toward the catalyst layer 302 (shown by arrow 320), such as into the chamber 310. In some aspects, the oxygen may be provided in the form of an oxygen-rich gas. As non-limiting examples, the oxygen may be provided via an air supply, the cathode exhaust outlet 234 described above with respect to FIG. 2, and/or a source of purified oxygen.

The hydrogen inlet 304 and the oxygen inlet 306 can be arranged such that the introduced hydrogen and oxygen mix in the presence of the catalyst in the catalyst layer 302. The heating element 312 can be utilized to increase the temperature of the catalyst in the catalyst layer 302 to a level suitable for facilitating combustion of the mixing hydrogen and oxygen. The combustion reaction of the introduced hydrogen and oxygen can produce heat and water. In some aspects, heat from the combustion process can maintain the suitable temperature of the catalyst layer 302, and the heating element 312 can be deactivated after the combustion process is initiated. Water products from the combustion process (such as water vapor, steam, and/or water droplets) and any unconsumed gas can be released from the catalytic burner system 300 via the system exhaust 308 (shown by arrow 322). As may be appreciated, the hydrogen content of matter passing through the catalytic burner system 300 can be significantly reduced and/or eliminated as a result of the catalytic combustion therein.

The catalytic burner system 300 may also include a heat transfer network 316. For example, the heat transfer network 316 may include pipes and/or other lines for conveying coolant fluid. In some aspects, the heat transfer network 316 may include a pump 324 configured to move the coolant fluid through the heat transfer network 316. In additional and/or alternative aspects, the coolant fluid may flow as a result of variations in temperature of the coolant fluid. In some aspects, lines of the heat transfer network 316 may overlap or be interwoven through the catalyst layer 302. Heat from the combustion process in the catalytic burner system 300 may be transferred to the coolant fluid as the coolant fluid passes through portions of the heat transfer network 316 that are arranged within a space in which combustion occurs, such as the chamber 310. The heat transfer network 316 can carry the heat via the coolant fluid to provide heat to another component, such as via a heat exchanger associated with the component. In some aspects, the chamber 310, heat transfer network 316, and/or the component to receive the heat are arranged closely together so as to minimize a distance and concomitant heat loss between objects.

Catalyst systems (such as, but not limited to, the catalytic burner system 300 described above with reference to FIG. 3) can provide a number of functions in conjunction with aircraft-based fuel cell systems (such as, but not limited to, the fuel cell systems 100 and/or 200 described above with reference to FIGS. 1 and 2). For example, FIG. 4 is a diagram illustrating an example of an aircraft-based fuel cell system 400 including a catalyst system 402 configured for treating exhaust 404 of a fuel cell assembly 406 according to certain embodiments. The fuel cell assembly 406 may include a fuel cell system (such as, but not limited to, the fuel cell systems 100 and/or 200 described above with reference to FIGS. 1 and 2) and related ancillaries. Non-limiting examples of ancillaries that may be associated with the fuel cell assembly 406 include blowers, compressors, pumps, fuel conditioners, fuel storage vessels, and other components configured to facilitate and/or improve the operation of the associated fuel cell system. Although one such ancillary, a hydrogen store 408, is depicted in FIG. 4 for ease of reference as a component separate from the fuel cell assembly 406, any suitable arrangement and/or combination of ancillaries may be utilized. Fuel containing hydrogen for the fuel cell assembly 406 may be provided from the hydrogen store 408 (as shown by arrow 412). Non-limiting examples of the hydrogen store 408 include a pressurized vessel for storing a fluid containing hydrogen, a gas containing hydrogen, a liquid containing hydrogen, a solid containing hydrogen, and any other device and/or medium that can store hydrogen to be utilized by the fuel cell assembly 406.

An outlet for exhaust 404 of a fuel cell assembly 406 can be coupled with the catalyst system 402. For example, the outlet for exhaust 404 may correspond to the anode exhaust outlet 236 and/or the cathode exhaust outlet 234 described above with respect to FIG. 2. The outlet for exhaust 404 can route exhaust 404 from the fuel cell assembly 406 to the catalyst system 402. The catalyst system 402 can burn excess hydrogen carried in the exhaust 404, thereby eliminating or reducing the level of hydrogen therein and converting the exhaust 404 into low-hydrogen exhaust 410.

Reducing the level of hydrogen conveyed in the exhaust 404 can reduce the risk of uncontrolled combustion of such hydrogen. Reducing the level of hydrogen can also allow exhaust from the cathode exhaust outlet 234 and the anode exhaust outlet 236 to be safely mixed. In some aspects, the outlet for exhaust 404 may be coupled with the catalyst system 402 in such a manner that exhaust from the anode exhaust outlet 236 and exhaust from the cathode exhaust outlet 234 are prevented from mixing until fully treated by the catalyst system 402. For example, exhaust from the anode 202 may be routed through the catalyst system 402 (i.e., so as to undergo a combustion reaction that consumes excess hydrogen) before mixing with exhaust from the cathode 206 that is routed so as to not undergo a combustion reaction in the catalyst system 402. In another example, exhaust from the cathode 206 and exhaust from the anode 202 are each routed through separate catalyst systems 402 before being combined. In some aspects, exhaust from the anode 202 and the cathode 206 are routed together into the catalyst system 402 for controlled combustion therein.

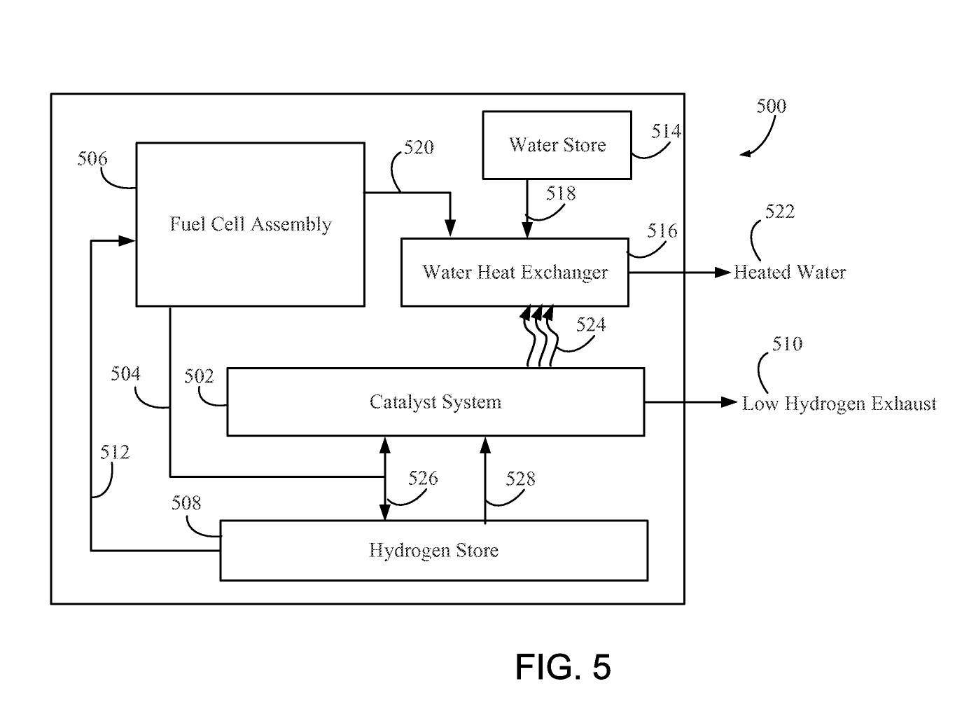

FIG. 5 is a diagram illustrating an example of an aircraft-based fuel cell system 500 having a catalyst system 502 configured for producing heated water 522 according to certain embodiments. Elements in FIG. 5 that have names and reference numbers similar to elements identified above with respect to FIG. 4 may be utilized in a like manner to provide the functions described in FIG. 4. However, such similar elements are not limited to the previously described configurations or functions and may yield additional or alternative functions and/or configurations, including those further described herein. In one illustrative example, the hydrogen store 508 may be configured to provide hydrogen directly to the catalyst system 502 (as shown by arrow 528). A direct supply of hydrogen may allow the catalyst system 502 to operate independent of the operation of the fuel cell assembly 506. For example, the catalyst system 502 may utilize the direct supply from the hydrogen store 508 to achieve a combustion reaction in circumstances in which the exhaust 504 from the fuel cell assembly 506 does not contain hydrogen (such as when the fuel cell assembly 506 is not in operation; when the fuel cell assembly 506 fully consumes hydrogen supplied thereto such that no excess hydrogen is introduced into the exhaust 504; and/or when the exhaust 504 is not routed through the catalyst system 502). In another illustrative example, a part or all of the hydrogen contained in the exhaust 504 may be routed into the hydrogen store 508 for subsequent use (as shown by arrow 526). In some aspects, the catalyst system 502 may consume hydrogen originating as a result of leakage. For example, the exhaust 504 communicated to the catalyst system 502 and/or hydrogen provided directly to the catalyst system 502 from the hydrogen store 508 may include hydrogen inadvertently released or leaked from the fuel cell assembly 506 and/or the hydrogen store 508. The catalyst system 502 may consume a part or all of such hydrogen leakage, thereby reducing the amount of stray combustible hydrogen and improving the overall safety of the fuel cell system 500.

The fuel cell system 500 can include a water heat exchanger 516. Hydrogen from the hydrogen store 508, from the exhaust 504 of the fuel cell assembly 506, or from some combination thereof can be combusted in the catalyst system 502 to produce heat 524. The heat 524 can be conveyed into the water heat exchanger 516, such as via the heat transfer network 316 described above with respect to FIG. 3. Water can be conveyed into the water heat exchanger 516 from a water source such as the fuel cell assembly 506 (as shown by arrow 520) and/or from a water store 514 aboard the aircraft (as shown by arrow 518). A non-limiting example of a water store 514 is a water storage tank used to contain potable water aboard the aircraft during flight. In some aspects, heat is transferred to the water within the water heat exchanger 516 by the water passing over lines carrying coolant fluid that was heated during passage through the catalyst system 502. In alternate aspects, the water heat exchanger 516 is configured so that the water to be heated is routed as a coolant fluid through the catalyst system 502. Regardless of the configuration of the water heat exchanger 516, the heat 524 conveyed to the water heat exchanger 516 can raise the temperature of the water passing through the water heat exchanger 516 to produce heated water 522. As may be appreciated, provision of water from the water store 514 may allow the catalyst system 502 to provide heated water 522 independent of the operation of the fuel cell assembly 506. For example, the catalyst system 502 may heat water from the water store 514 in circumstances in which water is not available from the fuel cell assembly 506 (such as when the fuel cell assembly 506 is not in operation and/or when the water from the fuel cell assembly 506 is not routed through the water heat exchanger 516).

As may be appreciated from the following illustrative examples, the temperature difference between the heated water 522 and the water initially introduced into the water heat exchanger 516 may depend upon the volume of water and the amount of heat 524 introduced into the water heat exchanger 516. Additionally, the amount of water and/or the amount of heat 524 conveyed to the water heat exchanger 516 can be controlled to yield a heated water 522 output of a desired volume and/or temperature. Heated water 522 of different volumes and/or temperatures may be desired for a variety of differing uses, including, but not limited to providing warmed hand-washing water, providing warmed water to prevent freezing of on-board pipes and conduits, providing hot water for a beverage maker (such as a coffee or espresso maker), providing warm water for a shower, providing hot water for washing dishes, providing steam for cooking ovens, and providing steam for sanitation purposes.

In a first illustrative example, water from the water store 514 is introduced (i.e., arrow 518) into the water heat exchanger 516 at an ambient temperature of approximately 20° C., and heat 524 transferred from the catalyst system 502 is harnessed to produce heated water 522 having a temperature of approximately 60° C. (such as may be useful for use in the lavatory 182 discussed above with regards to FIG. 1). In a second illustrative example, water produced during the chemical reaction in the fuel cell assembly 506 is introduced (i.e., arrow 520) into the water heat exchanger 516 within a pre-heated temperature range of approximately 60-80° C. (i.e., due to the heat produced in the chemical reaction). The pre-heated water is combined with the heat 524 within the water heat exchanger 516, and heated water 522 is produced having a temperature within an elevated temperature range of approximately 80-100° C. (such as may be useful for cooking use in the galley 184 discussed above with regards to FIG. 1). In a third illustrative example, water introduced into the water heat exchanger 516 includes water from the fuel cell assembly 506 and water from the water store 514. The fuel cell assembly 506 is operated within certain parameters to produce particular quantities of pre-heated water and exhaust 504. The water supplied from the water store 514 is regulated to supplement the amount of pre-heated water produced by the fuel cell assembly 506 such that a desired volume of the heated water 522 is obtained. The amount of hydrogen in the exhaust 504 is supplemented by regulating the direct flow 528 from the hydrogen store 508 until a sufficient rate of hydrogen is introduced into the catalyst system 502 to produce a sufficient amount of heat 524 in the water heat exchanger 516 to raise the temperature of the volume of heated water to a desired level.

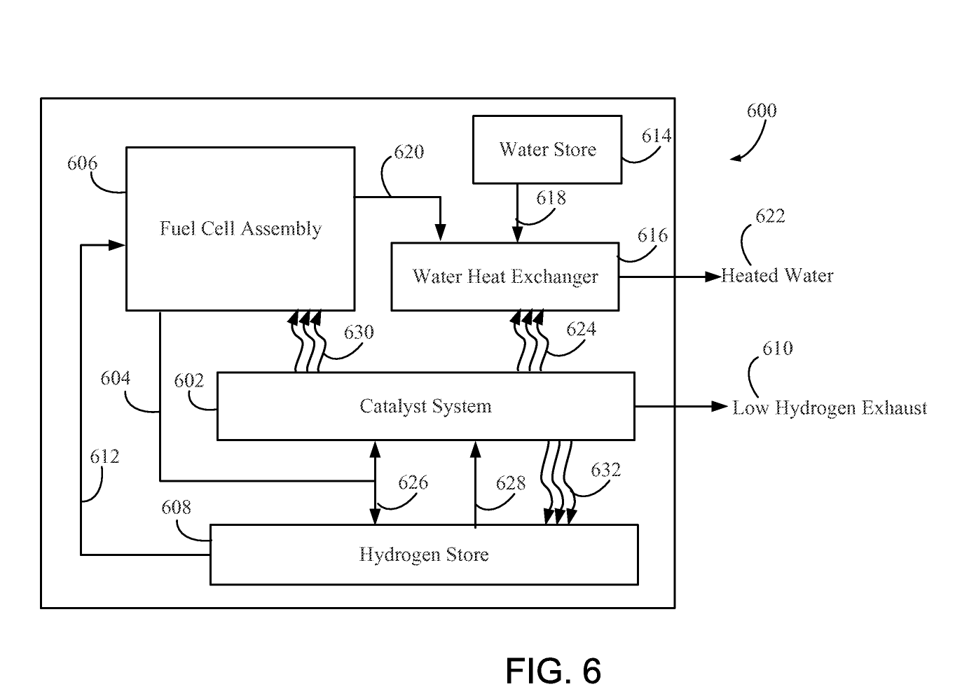

FIG. 6 is a diagram illustrating an example of an aircraft-based fuel cell system 600 having a catalyst system 602 configured for heating components of the fuel cell system 600 according to certain embodiments. Elements in FIG. 6 that have names and reference numbers similar to elements identified above with respect to FIGS. 4 and/or 5 may be utilized in a like manner to provide the functions described in FIGS. 4 and/or 5. However, such similar elements are not limited to the previously described configurations or functions and may yield additional or alternative functions and/or configurations, including those further described herein.

The hydrogen store 608 may supply hydrogen to the catalyst system 602 (as shown by arrow 628) to produce heat 630 and/or 632. The catalyst system 602 can be configured to convey the heat 630 and/or 632 to various components of the fuel cell system 600 (such as, but not limited to, the hydrogen store 608, and/or other subcomponents of the fuel cell assembly 606 and/or its ancillaries). For example, the fuel cell system 600 (or parts thereof) may undergo frozen or cold condition during operation, storage, and/or any other life cycle phase. Any components containing water may be damaged or rendered inoperable due to ice forming from the water experiencing temperatures below freezing. Utilizing the catalyst system 602 to heat the components in such scenarios may prevent damage or inoperability of the fuel cell system 600 or parts thereof. For example, the catalyst system 602 may be initiated before the rest of the fuel cell system 600 in order to provide heat 630 and/or 632 that may melt ice that might otherwise prevent the fuel cell system (or components thereof) from starting.

In some aspects, components of the fuel cell system 600 may operate at a greatest efficiency when operating within a certain temperature range. The catalyst system 602 may provide the heat 630 and/or 632 for regulating the temperature of such a component within the desired temperature range. For example, the heat 630 and/or 632 can be conveyed to the component to increase a temperature into the desired range. Alternatively, the heat 630 and/or 632 may be utilized with heat-driven cooling devices (such as absorption chillers) to decrease a temperature into the desired range.

In some aspects, the fuel cell system 600 can be configured to selectively perform the functions described with regards to FIGS. 4-6. For example, the fuel cell system 600 may turn functions on or off so as to simultaneously and/or sequentially perform any of these functions in any order. In one illustrative example, the catalyst system 602 can be utilized during a start-up mode to warm components of the fuel cell system 600. The catalyst system 602 may be utilized in an operation mode to simultaneously purify exhaust 604 from the fuel cell assembly 606 and heat water in the water heat exchanger 616. The exhaust treatment function can be terminated (such as by directing excess hydrogen into the hydrogen store 608 as shown by arrow 626) without terminating the water heating function. Additionally or alternatively, the component heating function can be maintained and/or reactivated to adjust temperatures of the components, such as to improve operating efficiency. Water supplied to the water heat exchanger 616 from the fuel cell assembly 606 (as shown by arrow 620) and/or from the water store 614 (as shown by arrow 618) may be selectively regulated, eliminated, and/or established, such as by the use of one or more valves. Hydrogen supplied to the catalyst system 602 via exhaust 604 from the fuel cell assembly 606 and/or from the hydrogen store 608 (as shown by arrow 628) may be selectively regulated, eliminated, and/or established, such as by the use of one or more valves. It may also be appreciated that although FIG. 6 depicts a fuel cell system 600 with a single catalyst system configured to selectively perform these various functions, other arrangements are possible, such as the provision of two or more catalyst systems 602 to individually and/or collectively perform one or more of these functions selectively and/or continuously.

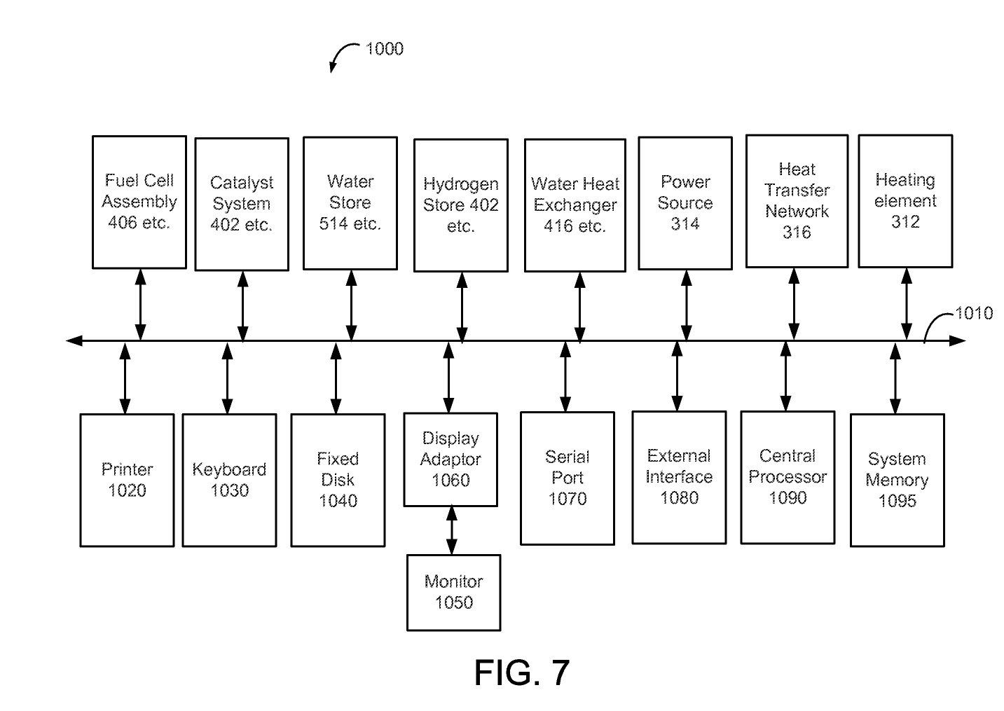

In embodiments, any of the entities described herein may be embodied in part or in whole by a computer that performs any or all of the functions and operations disclosed. FIG. 7 is a diagram of a computer apparatus 1000, according to certain exemplary embodiments. The various participants and elements in the previously described figures may use any suitable number of computer apparatuses 1000 and/or any suitable number of subsystems or components in the computer apparatus 1000 to facilitate the functions described herein. Some examples of subsystems or components in the computer apparatus 1000 are shown in the previously described figures. The subsystems or components disclosed herein may be interconnected via the system bus 1010 or other suitable connection, including wireless connections. In addition to the subsystems described above, additional subsystems such as a printer 1020, keyboard 1030, fixed disk 1040 (or other memory comprising computer-readable media), monitor 1050, which is coupled to a display adaptor 1060, and others are shown. Peripherals and input/output (I/O) devices (not shown) can be connected to the computer apparatus 1000 by any number of means known in the art, such as a serial port 1070. For example, the serial port 1070 or an external interface 1080 may be used to connect the computer apparatus 1000 to a wide area network such as the Internet, a mouse input device, or a scanner. The interconnection via the system bus 1010 allows a central processor 1090 to communicate with each subsystem and to control the execution of instructions from a system memory 1095 or the fixed disk 1040, as well as the exchange of information between subsystems. The system memory 1095 and/or the fixed disk 1040 may embody a non-transitory computer-readable medium.

The software components or functions described in this application may be implemented via programming logic controllers (“PLCs”), which may use any suitable PLC programming language. In other embodiments, the software components or functions described in this application may be implemented as software code to be executed by one or more processors using any suitable computer language such as, for example, Java, C++ or Perl using, for example, conventional or object-oriented techniques. The software code may be stored as a series of instructions or commands on a computer-readable medium, such as a random access memory (“RAM”), a read-only memory (“ROM”), a magnetic medium such as a hard-drive or a floppy disk, an optical medium such as a CD-ROM, or a DNA medium. Any such computer-readable medium may also reside on or within a single computational apparatus, and may be present on or within different computational apparatuses within a system or network.

Aspects of the invention can be implemented in the form of control logic in hardware (circuitry, dedicated logic, etc.), software (such as is run on a general purpose computing system or a dedicated machine), firmware (embedded software), or any combination thereof. The control logic may be stored in an information storage medium as a plurality of instructions adapted to direct one information processing device or more than one information processing devices to perform a set of operations disclosed in embodiments of the invention. Based on the disclosure and teachings provided herein, a person of ordinary skill in the art will appreciate other ways and/or methods to implement the invention.

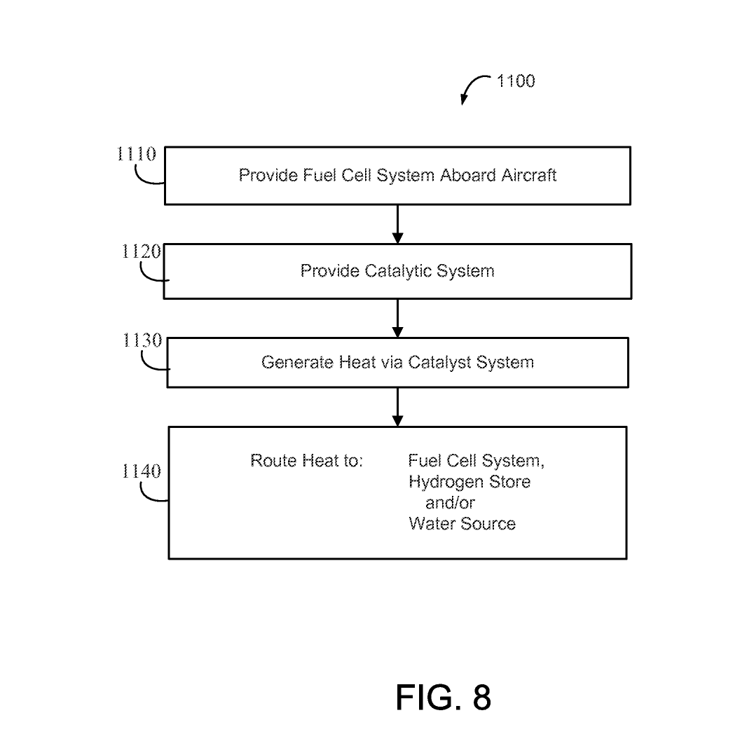

According to certain embodiments, the operation of one or more systems described herein is illustrated in a simplified flow diagram shown in FIG. 8. FIG. 8 illustrates a method 1100 for distributing heat from a catalyst system associated with a fuel cell system aboard an aircraft according to certain embodiments. At operation 1110, the method can include providing a fuel cell system aboard an aircraft. For example, the fuel cell system can be configured to receive a hydrogen input comprising hydrogen from a hydrogen storage vessel, receive an oxygen input comprising a fluid having an initial oxygen content, and convert the hydrogen input and the oxygen input so as to yield products. The products can include a water product comprising water, a thermal product comprising thermal energy, an oxygen-depleted product comprising the fluid having a second oxygen content lower than the initial oxygen content, an electric product comprising electrical power, and an exhaust product comprising excess hydrogen. The fuel cell system can also be configured to supply the water product, the thermal product, the oxygen-depleted product, and/or the electric product to a first operational system of the aircraft. At operation 1120, the method can include providing a catalyst system. For example, the catalyst system can be configured to receive and combust hydrogen supplied thereto by the exhaust product and/or the hydrogen storage vessel. At operation 1130, the method can include generating a heat component via combustion of hydrogen in the catalyst system. At operation 1140, the method can include routing the heat component to the fuel cell system, the hydrogen storage vessel, and/or a water source supplied to a second operational system of the aircraft. In some aspects, the second operational system and the first operational system of the aircraft are the same. For example, the fuel cell system may route the water product to an operational system of the aircraft, and the heat component can be routed to heat said water product en route to the operational system of the aircraft.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fuel cell system for an aircraft, the fuel cell system comprising:
(A) a hydrogen storage vessel;
(B) a fuel cell assembly configured to:
(i) receive a hydrogen input comprising hydrogen from the hydrogen storage vessel,
(ii) receive an oxygen input comprising a fluid having an initial oxygen content,
(iii) convert the hydrogen input and the oxygen input so as to yield products including:
(a) a water product comprising water,
(b) a thermal product comprising thermal energy,
(c) an oxygen-depleted product comprising the fluid having a second oxygen content lower than the initial oxygen content, and
(d) an electric product comprising electrical power; and
(iv) supply the water product, the thermal product, the oxygen-depleted product, and/or the electric product to an operational system of the aircraft; and
(C) a catalyst system configured to receive and combust hydrogen supplied thereto from at least one of the fuel cell assembly or the hydrogen storage vessel.

2. The fuel cell system of claim 1, wherein the catalyst system is configured to receive an exhaust from the fuel cell assembly and combust hydrogen from said exhaust.

3. The fuel cell system of claim 1, wherein the catalyst system is configured to heat water supplied to an operational system of the aircraft.

4. The fuel cell system of claim 1, wherein the catalyst system is configured to heat components associated with the fuel cell assembly.

5. The fuel cell system of claim 1, wherein the catalyst system is configured to selectively:
(a) receive an exhaust from the fuel cell assembly and combust hydrogen from said exhaust;
(b) heat water supplied to an operational system of the aircraft; and/or
(c) heat components associated with the fuel cell assembly.

6. The fuel cell system of claim 1, wherein the catalyst system is configured to selectively receive hydrogen from the fuel cell assembly and configured to selectively receive hydrogen from the hydrogen storage vessel.

7. The fuel cell system of claim 1, further comprising a water heat exchanger configured to receive water, receive thermal energy from combustion in the catalyst system, and supply the water heated by the thermal energy to an operational system of the aircraft.

8. The fuel cell system of claim 7, wherein the water heat exchanger is configured to receive water from the water product of the fuel cell assembly.

9. The fuel cell system of claim 7, further comprising a water storage vessel, wherein the water heat exchanger is configured to receive water from the water storage vessel.

10. The fuel cell system of claim 9, wherein the water heat exchanger is configured to selectively receive water from the water product of the fuel cell assembly and to selectively receive water from the water storage vessel.

11. The fuel cell system of claim 1, wherein the fuel cell assembly comprises:
an anode;
a cathode;
a hydrogen intake configured to direct the hydrogen input toward the anode;
an oxygen intake configured to direct the oxygen input toward the cathode;
an electrically conductive path between the anode and the cathode;
an electrolyte configured to permit movement therethrough of ions between the anode and the cathode and to resist movement therethrough of electrons, thereby directing the electrons along the electrically conductive path;
an anode outlet configured to exhaust hydrogen from the hydrogen input that is not converted into products by the fuel cell assembly; and
a cathode outlet configured to exhaust the oxygen-depleted product.

12. The fuel cell system of claim 11, wherein the catalyst system is configured combust hydrogen from the anode outlet.

13. The fuel cell system of claim 1, wherein the catalyst system is configured to receive and combust an initial amount of hydrogen supplied thereto and provide a treated exhaust having a lower content of hydrogen than the initial amount of hydrogen.

14. The fuel cell system of claim 1, wherein operation of the catalyst system creates a heat component and wherein the heat component is routed to a heat exchanger in order to deliver heat to a water source.

15. The fuel cell system of claim 14, wherein the water source comprises the water product from the fuel cell.

16. The fuel cell system of claim 1, wherein operation of the catalytic burner creates a heat component and wherein the heat component is routed to the fuel cell assembly.

17. The fuel cell system of claim 1, wherein operation of the catalytic burner creates a heat component and wherein the heat component is routed to the hydrogen storage vessel.

18. A method comprising:
(A) providing a fuel cell system for an aircraft, the fuel cell system configured to:
(i) receive a hydrogen input comprising hydrogen from a hydrogen storage vessel;
(ii) receive an oxygen input comprising a fluid having an initial oxygen content;
(iii) convert the hydrogen input and the oxygen input so as to yield products including:
(a) a water product comprising water,
(b) a thermal product comprising thermal energy,
(c) an oxygen-depleted product comprising the fluid having a second oxygen content lower than the initial oxygen content,
(d) an electric product comprising electrical power, and
(e) an exhaust product comprising excess hydrogen; and
(iv) supply the water product, the thermal product, the oxygen-depleted product, and/or the electric product to a first operational system of the aircraft;
(B) providing a catalyst system configured to receive and combust hydrogen supplied thereto by the exhaust product and/or the hydrogen storage vessel;
(C) generating a heat component via combustion of hydrogen in the catalyst system; and
(D) routing the heat component to the fuel cell system, the hydrogen storage vessel, and/or a water source supplied to a second operational system of the aircraft.

19. The method of claim 18, the second operational system of the aircraft comprises the first operational system of the aircraft.

20. The method of claim 18, wherein the water source comprises the water product from the fuel cell system.
